(19) United States
(12) Patent Application Publication
(10) Pub. No.: US 2005/0289521 A1
(43) Pub. Date: Dec. 29, 2005

(54) Method for controlling embedded system device

(76) Inventors: Fan-Sheng Lin, Taipei City (TW); Chao-Kuei Chung, Taipei City (TW)

Correspondence Address: BIRCH STEWART KOLASCH & BIRCH, PO BOX 747, FALLS CHURCH, VA, 22040-0747, US

(21) Appl. No.: 10/928,090

(22) Filed: Aug. 30, 2004

(30) Foreign Application Priority Data
Jun. 25, 2004 (TW) 093118500

(51) Int. Cl. G06F 9/45

(52) U.S. Cl. 717/138; 707/9

(57) ABSTRACT

A method for controlling an embedded system device via standard file I/O from a host computer linked to the embedded system device is disclosed. In a preferred embodiment, the embedded system device and the host computer is connected through USB. The embedded system device is controlled via management of a system control file through a file I/O interface displaying in the host computer. The system control file in the embedded system device can be read, stored, modified and updated through the file I/O interface.

### FIELD OF THE INVENTION

The invention generally relates to a control method of embedded system device, and in particular relates to a method of controlling an embedded system device linked to a host computer by standard file I/O.

### BACKGROUND OF THE INVENTION

As shown in FIG. 1A, an embedded system device 20 is conventionally controlled through proprietary formats. The proprietary formats are proprietary software programs provided by software developers for the applications of specific embedded system devices. Because the protocol interface of each software developer is dependent, the embedded system device 20 has to be linked via proprietary class interfaces 2 and 3 for being controlled by a host computer 10. The flexibility of software development and application on the proprietary formats are limited.

To control the embedded system device 20 through proprietary protocols, additional proprietary class interfaces 2 and 3 are required besides the embedded system controller 22 working with external memory 23 for system control information access and other control processes. Therefore, each time when new features are required, the embedded system controller 22 has to be re-developed. Since the complication of relative technology is getting higher, the development time of embedded system device 20 is also becoming longer. Moreover, this kind of design gives the embedded system controller 22 a large burden that lowers the efficiency of the embedded system device 20.

Therefore, under the conventional structure of embedded system device 20, the software developer requires professional abilities to develop the driver for linking the device 20 to the host computer 10 and accomplishing the control. Meanwhile, in order to control the embedded system device 20 through the host computer 10, the host computer 10 must be installed with driver of the proprietary class interface 2 to provide a proprietary system control interface 1 for user to operate. Also, the proprietary system control interface 1 usually requires a period of learning time for user to accustom to. Therefore, the conventional proprietary protocols are rather complicated for both software developers and users.

As protocol interfaces being continuously developed, nowadays there have been some universal protocol interfaces available for users to develop relative software. For example, Universal Serial Bus (USB) is the most well-supported and widely used interface that almost every host computer 10 has built-in driver for it.

Therefore, to solve to the problem of lacking of friendly human-machine interface for general embedded system devices, a possibility is to utilize the resources of general protocol interfaces and provide an easier operation method for controlling embedded system device 20. The general protocol interface gets rid of inconvenience of proprietary protocols, saves the time of software developer in the unnecessary development of driver, and save the time of users in learning the operation because the user is familiar to the general protocol interface. This is an important issue in the development of future embedded system devices 20.

### SUMMARY OF THE INVENTION

The object of the invention is to solve the problem of lacking of user-friendly and designer-friendly control interface for general embedded system devices and to provide a method for controlling the embedded system device via standard file I/O from a host computer linked to the embedded system device.

In a preferred embodiment of the invention, an USB is used as a connection interface between the embedded system device and the host computer. A system control file established in the embedded system device that can be read, stored, modified and updated via a file I/O interface accomplishes the management control of the embedded system device.

When the system control file has to be modified as the host computer changes, the invention provides an update manner for synchronous update of the embedded system device. In the same way, when the system control file has to be modified as the embedded system device changes, the invention provides an update manner for synchronous update of the host computer.

The method for controlling embedded system device according to the invention provides an easy-operated interface for users, and saves software development time for the developers so as to be a win-win solution.

### BRIEF DESCRIPTION OF THE DRAWINGS

The invention will become more fully understood from the detailed description given hereinbelow. However, this description is for purposes of illustration only, and thus is not limitative of the invention, wherein:

FIG. 1A is a block diagram of a conventional embedded system device;

FIG. 1B is a block diagram of an embedded system device of the invention;

FIG. 2 is a flowchart of process of linking the embedded system device to a host computer and displaying a system control file on a system control interface of the invention;

FIG. 3A is a flowchart of file management via a host computer in the invention;

FIG. 3B is a flowchart of file management via an embedded system device in the invention;

FIG. 4A is a flowchart of file synchronization via a host computer in the invention; and

FIG. 4B is a flowchart of file synchronization via an embedded system device in the invention.

### DETAILED DESCRIPTION OF THE INVENTION

The invention provides a method of controlling an embedded system device 20 linked to a host computer 10. In a preferred embodiment, a USB is used as a connection interface between the two.

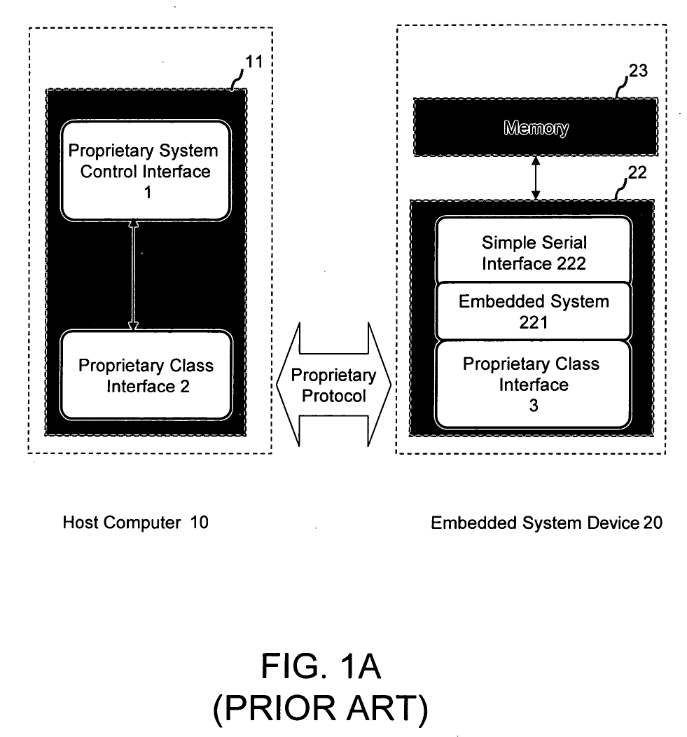

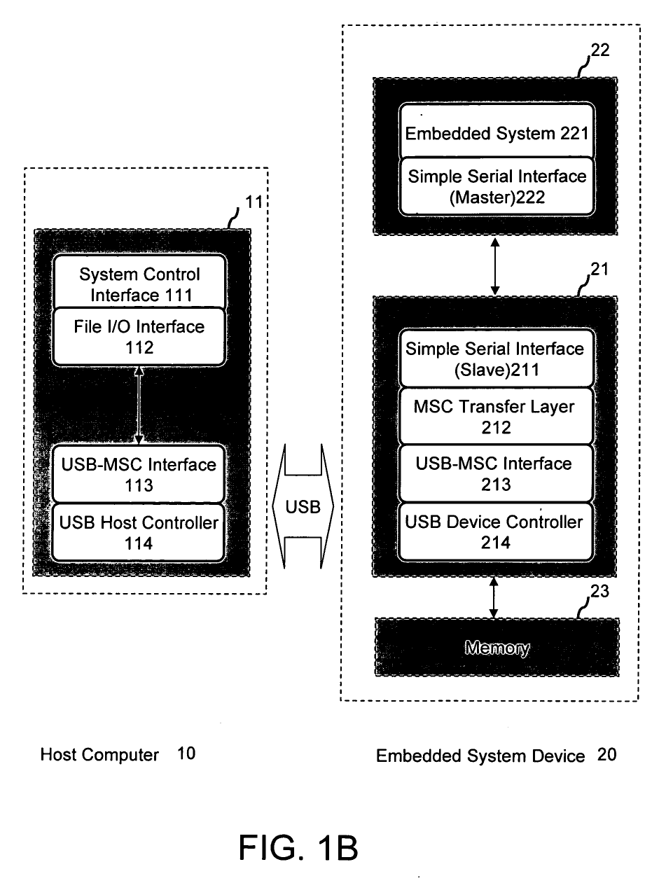

FIG. 1B shows a block diagram of an embedded system device of the invention. Basically, the embedded system device 20 includes a smart I/O controller 21, an embedded system controller 22 and memory 23. The smart I/O controller 21 controls the communication among the host computer 10, the embedded system controller 22 and the memory 23. The software construction of the smart I/O controller 21 includes an “simple serial interface (Slave) 211” for communication with the embedded system controller 22; a “MSC transfer layer 212” for updating the system control file; a “USB-MSC interface 213” for parsing the commands and a “USB device controller 214” for communication with the host computer 10.

The software construction of the embedded system controller 22 includes an “embedded system 221” and a “simple serial interface (Master) 222” for communication with the smart I/O controller 21.

The memory 23 is used to store data of the application software, system control file, passwords and so on. The memory can be of flash memory or electrically erasable programmable read only memory (EEPROM). In other embodiments, the memory 23 can also be included in the smart I/O controller 21.

The host computer 10 includes an operation system 11. The software structure includes a “USB Mass Storage Class (USB-MSC) interface 113” corresponding to the smart I/O controller 21 of the embedded system device 20 for parsing the commands and a “USB host controller 114” for communication with the embedded system device 20. The operation system 11 also includes a system control interface 111 and a file I/O interface 112 provided by the application software of the embedded system device 20 for managing the system control file.

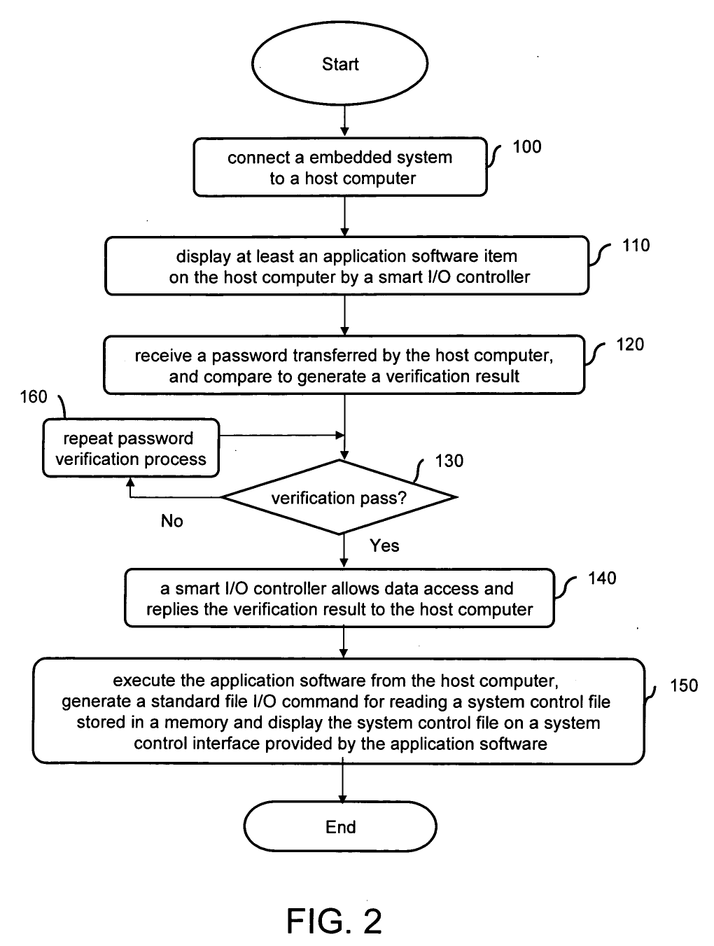

FIGS. 2 to 4B illustrate the major control method of an embedded system device of the invention. In which, FIG. 2 is a flowchart of process of linking the embedded system device 20 to a host computer 10 and displaying a system control file on a system control interface. First, connecting an embedded system device 20 to a host computer 10 (step 100). Preferably, USB interfaces, i.e. USB host controller 114 and USB device controller 214, are used. Then, displaying at least an application software item provided by the smart I/O controller 21 of the embedded system device 20 on the host computer 10 (step 110). Then, executing the application software chosen from the operation system 11 of the host computer 10. The application software generates a system control interface 111. Meanwhile, a standard file I/O interface 112 generates a file I/O interface for reading the system control file corresponding to the application software and stored in the memory 23 of the embedded system device 20, and returns and displays the system control file on the system control interface 111 (step 150). Thus, the management of the system control file is achieved via the system control interface 111 of the host computer 10. The files stored in the memory 23 are text files or binary files.

In order to assure that legal users take the operations, the method of the invention further includes a step of password verification after the step 100. The process is as follows. The smart I/O controller 21 receives the password transferred by the operation system 11 of the host computer 10, and compares to get a verification result (step 120). If the password is the same of that stored in the memory 23, the verification passes (step 130). Otherwise, the verification fails. When pass, the smart I/O controller 21 of the embedded system device 20 allows data access and replies the verification result to the host computer 10 (step 140). Then, executing said application software from the host computer, generating a standard file I/O command for reading a system control file stored in the memory and displaying the system control file on a system control interface provided by the application software (step 150). On the contrary, when verification fails, re-trials of password input in predetermined times is allowed. In other words, the steps 120 to 130 are repeated (step 160). Other conventional password verification processes can be applied herein.

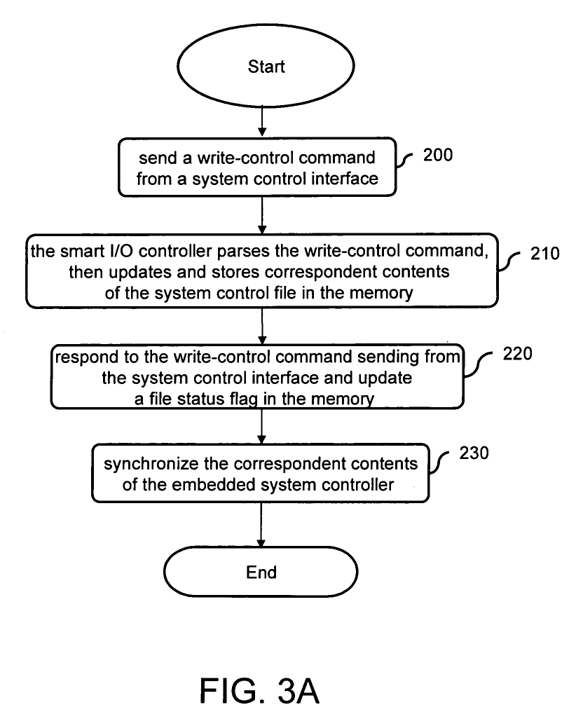

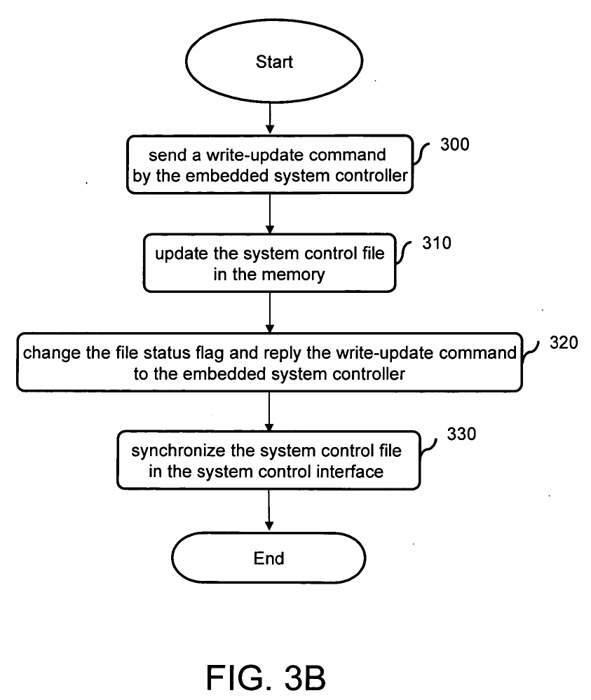

When the contents of system control file being displayed on the system control interface 111 of the host computer 10, some file management processes are executed as shown in FIG. 3A. The embedded system device 20 first receives write-control command from the system control interface 111 (step 200). The write-control command matches with standard file I/O format of the file I/O interface 112. Then, the smart I/O controller 21 of the embedded system device 20 parses the write-control command, updates and stores correspondent contents in the memory 23 (step 210). The parse process is operated via the USB-MSC interface 213. After the update and storage finishes, the smart I/O controller 21 responds to the control input commands coming from the system control interface 111 and updates the file status flag in the memory 23 (step 220). The embedded system controller 22 of the embedded system device 20 verifies the update of the file status flag, then, synchronizes the correspondent contents of the embedded system controller 22 (step 230). The synchronization is to synchronize the same contents in the embedded system 221 with the system control file updated and stored in the memory 23. The system control file management through the host computer 10 is then accomplished.

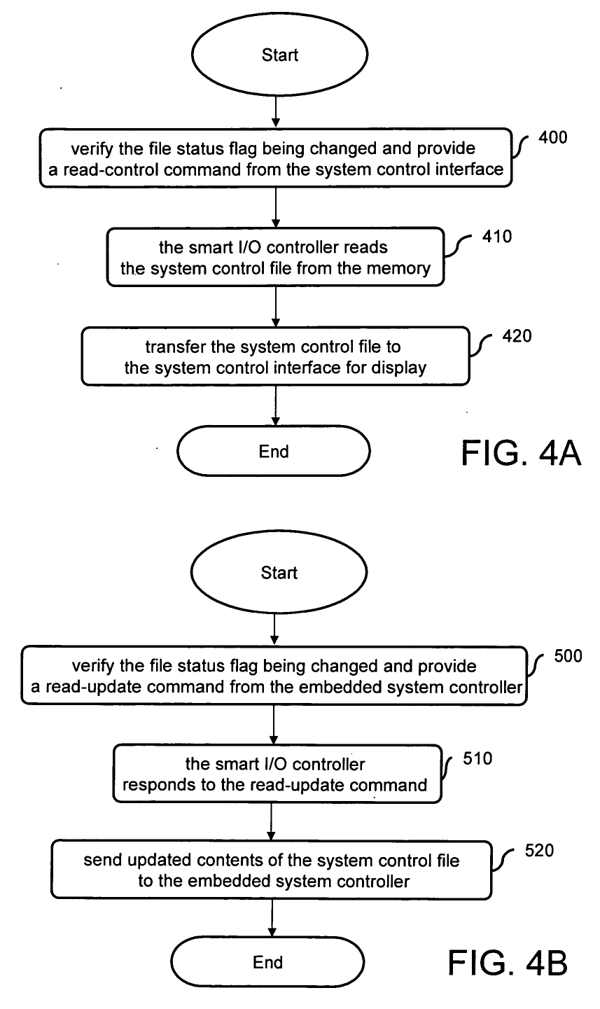

The process of step 230 is further illustrated in FIG. 4B. The synchronization of the embedded system controller 22 is the same as process of reading system control file from the embedded system controller 22. The embedded system controller 22 first verifies the file status flag being changed, then, provides a read-update command to the smart I/O controller 21 (step 500). The read-update command replies with simple serial interface format. Then, the smart I/O controller 21 responds to the reading update command (step 510). Finally, the updated contents of the system control file are returned to the embedded system controller 22 for further operation (step 520), and the synchronization of the embedded system controller 22 is finished. Meanwhile, the smart I/O controller 21 retrieves the file status flag.

Practically, the synchronization can be determined by different file status flags. That is, according to different file status flags corresponding to different requirements of file updates, some update contents that do not directly influence the current operation of the embedded system controller 22 do not execute the synchronization.

Besides the controls form the host computer 10 to the embedded system device 20, sometimes the system control file updates have to be executed from the embedded system controller 22 due to operational requirements of the embedded system device 20. In that case, the system control file displayed on the system control interface 111 of the host computer 10 can be influenced. Therefore, the invention also provides a process of managing system control file from the embedded system device 20 as described below.

Referring to FIG. 3B, the embedded system controller 22 of the embedded system device 20 provides a write-update command to the smart I/O controller 21 for asking update of the system control file (step 300). The write-update command matches with the simple serial interface formats (such as I2C, 2-Wire, 4-Wire, SPI, etc.). Then the smart I/O controller 21 updates the system control file in the memory according to the write-update command (step 310). After the update, the file status flag is changed and a reply to the write-update command is provided to the embedded system controller 22 (step 320). The system control interface 111 of the host computer 10 detects the change of file status flag, then, synchronizes the system control file in the system control interface 111 of the host computer 10 (step 330).

FIG. 4A is a flowchart of updating the displayed contents of system control file on the host computer 10 through file synchronization. The process relates to the host computer 10 that re-reads system control file to the system control interface 111. When the system control interface 111 of the host computer 10 verifies the file status flag being changed, it sends again a read-control command (step 400). The read-control command complies with file I/O interface formats. The smart I/O controller 21 of the embedded system device 20 then reads the updated system control file from the memory 23 (step 410) and transfers to the system control interface 111 for display (step 420). The process is also operated via the USB-MSC interface 213. Then, the synchronization of system control file in the system control interface 111 of the host computer 10 is accomplished.

Basically, the synchronization is made each time when the content of system control file changes. However, as described above, different file status flags can be defined for determining whether the synchronization is required or not.

By means of aforesaid methods, the invention is capable of controlling an embedded system device 20 through standard file I/O. The system control file can be managed through either the host computer 10 or the embedded system device 20. Though a data synchronization process, the system control file is kept consistent.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A method for controlling an embedded system device having an embedded system controller, a smart I/O controller and a memory; said embedded system device is capable of linking to a host computer for being controlled through standard file I/O, said method comprises steps of:
connecting said embedded system device to said host computer;
displaying at least an application software item on said host computer by said smart I/O controller; and
executing said application software from said host computer, generating a standard file I/O command for reading a system control file stored in said memory and displaying said system control file on a system control interface provided by said application software.

2. The method for controlling an embedded system device according to claim 1 wherein said step of connecting said embedded system device to said host computer is taken through a USB interface.

3. The method for controlling an embedded system device according to claim 1 wherein said step of connecting said embedded system device to said host computer further comprises a password verification process at least comprises steps of:
receiving by said smart I/O controller an password transferred from said host computer;
checking said password and generating a verification result; and
allowing data access and replying said verification result to said host computer when said verification passes.

4. The method for controlling an embedded system device according to claim 1 wherein said system control file is a text file.

5. The method for controlling an embedded system device according to claim 1 wherein said system control file is a binary file.

6. The method for controlling an embedded system device according to claim 1 wherein said step of executing said application software further comprises a process of updating system control file via said host computer at least comprises steps of:
receiving a write-control command by said system control interface of said embedded system device;
parsing said write-control command by said smart I/O controller and updating and storing said system control file in said memory;
replying said write-control command to said system control interface by said smart I/O controller and updating a file status flag; and
detecting and verifying changes of said file status flag and synchronizing correspondent contents of said embedded system controller.

7. The method for controlling an embedded system device according to claim 6 wherein said write-control command complies with standard file I/O format of a file I/O interface.

8. The method for controlling an embedded system device according to claim 6 wherein said step of parsing said control input command by said smart I/O controller is operated via a USB Mass Storage Class interface.

9. The method for controlling an embedded system device according to claim 6 wherein said step of synchronizing correspondent file of said embedded system controller further comprises steps of:
providing a read-update command from said embedded system controller;
responding said read-update command by said smart I/O controller; and
returning updated contents of said system control file to said embedded system controller by said smart I/O controller.

10. The method for controlling an embedded system device according to claim 9 wherein said read-update command complies with a simple serial interface.

11. The method for controlling an embedded system device according to claim 10 wherein said simple serial interface is selected from the group consisting of I2C, 2-Wire, 4-Wire, and SPI.

12. The method for controlling an embedded system device according to claim 1 wherein step of executing said application software; said updating process further comprises a process of updating system control file via said embedded system device at least comprises steps of:
providing a write-update command from said embedded system controller;
updating said system control file in said memory by said smart I/O controller;
changing a file status flag by said smart I/O controller and responding said write-update command to said embedded system controller; and
detecting and verifying change of file status flag and synchronizing said system control file in said system control interface.

13. The method for controlling an embedded system device according to claim 12 wherein said write-update command complies with a simple serial interface.

14. The method for controlling an embedded system device according to claim 13 wherein said simple serial interface is selected from the group consisting of I2C, 2-Wire, 4-Wire, and SPI.

15. The method for controlling an embedded system device according to claim 12 wherein said step of synchronizing said system control file in said system control interface further comprises steps of:
providing a read-update command from said system control interface;
reading and transferring said system control file from said memory by said smart I/O controller; and
returning said system control file by said smart I/O controller and displaying on said system control interface.

16. The method for controlling an embedded system device according to claim 15 wherein said read-control command complies with standard file I/O format of said file I/O interface.

17. The method for controlling an embedded system device according to claim 15 wherein said step of reading and transferring said system control file from said memory by said smart I/O controller is operated via a USB Mass Storage Class interface.
